(19) United States
(12) Patent Application Publication
(10) Pub. No.: US 2008/0063270 A1
(43) Pub. Date: Mar. 13, 2008

(54) Method and Apparatus for Determining a Location Associated With an Image

(75) Inventors: James G. McClelland, Longmont, CO (US); Christopher J. Comp, Longmont, CO (US); Gerald J. Smith, Boulder, CO (US); Walter S. Scott, Boulder, CO (US); Woodson Bercaw, Berthoud, CO (US)

Correspondence Address: PAUL, HASTINGS, JANOFSKY & WALKER LLP, 875 15th Street, NW, Washington, DC, 20005, US

(73) Assignee: DIGITALGLOBE, INC., Longmont, CO (US)

(21) Appl. No.: 11/571,293

(22) PCT Filed: Jun. 24, 2005
(86) PCT No.: PCT/US05/22961

§ 371 Date: Dec. 26, 2006

Related U.S. Application Data
(60) Provisional application No. 60/521,729, filed on Jun. 25, 2004.

(51) Int. Cl. G06K 9/00

(52) U.S. Cl. 382/170

(57) ABSTRACT

The adverse effects of various sources of error present in satellite imaging when determining ground location information are reduced to provide more accurate ground location information for imagery, thereby rendering the information more useful for various entities utilizing the images. The determination of ground location coordinates associated with one or more pixels of an image acquired by an imaging system aboard a satellite or other remote platform includes obtaining a first earth image associated with a first earth view, obtaining a second earth image associated with a second earth view, the second earth image not overlapping the first earth image, and using known location information associated with the first earth image to determine location information associated with the second earth image.

### CROSS-REFERENCE TO RELATED APPLICATIONS

This application claims priority to U.S. Provisional Patent Application No. 60/521,729 filed Jun. 25, 2004, entitled “METHOD AND APPARATUS FOR DETERMINING A LOCATION ASSOCIATED WITH AN IMAGE,” which is incorporated by reference herein in its entirety.

### FIELD OF THE INVENTION

The present invention is directed to the determination of ground coordinates associated with imagery and more particularly to the translation of compensated coordinate information from one or more images to other images produced by an imaging system.

### BACKGROUND

Remote sensing systems in present day satellite and airborne applications generally provide images which may be processed to include rows of pixels that make up an image frame. In many applications, it is desirable to know the ground location of one or more pixels within an image. For example, it may be desirable to have the ground location of the image pixels expressed in geographic terms such as longitude, latitude, and elevation. A number of conventions are used to express the precise ground location of a point. Typically, a reference projection, such as Universal Transverse Mercator (UTM) is specified along with various horizontal and vertical datums such as the North American Datum of 1927 (NAD27), the North American Datum of 1983 (NAD83), and the World Geodetic System of 1984 (WGS84). Furthermore, for images within the United States, it may be desirable to express the location of pixels or objects within an image in PLSS (Public Land Survey System) coordinates such as township/range/section within a particular state or county.

In order to derive accurate ground location information for an image collected by a remote imaging system and then express it in one of the above listed, or other, standards, the state of the imaging system at the time of image collection must be known to some degree of certainty. There are numerous variables comprising the state of the imaging system that determine the precise area imaged by the imaging system. For example, in a satellite imaging application, the orbital position of the satellite, the attitude of imaging system, and various other factors including atmospheric effects and thermal distortion of the satellite or its imaging system, all contribute to the precision to which the area imaged by the imaging system can be determined. Error in the knowledge of each of these factors results in inaccuracies in determining the ground location of areas imaged by the imaging system.

### SUMMARY

The present invention has recognized that many, if not all, of the factors used to generate ground location information for raw image data collected by remote sensing platforms are subject to errors that lead to the derivation of inaccurate ground location information for a related image.

The present invention reduces the adverse effects of at least one source of error and provides for derivation of more accurate ground location information for imagery, thereby rendering the information more useful for various entities utilizing the images. Consequently, if an interested entity receives a ground image, the locations of various features within the ground image are known with increased accuracy, thereby facilitating the ability to use such images for a wider variety of applications.

In one embodiment, the present invention provides a method for determining ground location coordinates for pixels within a satellite image. The method includes the steps of (a) obtaining a first image of a first earth view; (b) locating at least a first pixel in the first image, the first pixel corresponding to a point having known earth location coordinates; (c) determining an expected pixel location of the point in the first image using at least one of attitude, position, and distortion information available for the satellite; (d) calculating at least one compensation factor based on a comparison between the expected pixel location of the point and the known location of the first pixel; (e) obtaining a second image of a second earth view, the second image not overlapping the first image; and (f) determining earth location coordinates for at least one pixel within the second image using the compensation factor in conjunction with attitude, position, and distortion information available for the satellite.

The compensation factor may be calculated by solving a set of equations relating position, attitude, distortion, and ground location information for an image utilizing known ground location, distortion, and position information to adjust the attitude of the satellite. The adjusted attitude of the satellite is then used as the compensation factor. Calculation of the compensation factor may also be augmented with covariance matrices, balancing the uncertainties or setting the uncertainties in one or more of the matrices to be near zero, and solving another of the matrices to obtain satellite attitude information. The satellite attitude information is then used as the compensation factor when determining earth location coordinates for the second image. The second image may be collected by the imaging system before or after the collection of the first image.

Another embodiment of the invention provides a method for determining location information of an earth image from a remote imaging platform. The method includes the steps of: (a) obtaining a first earth image associated with a first earth view; (b) obtaining a second earth image associated with a second earth view, the second earth image not overlapping the first earth image; and (c) using known location information associated with the first earth image to determine location information associated with the second earth image.

Yet another embodiment of the invention provides a satellite image of an earth area comprising a plurality of pixels and earth location coordinates of at least one of the pixels. The pixels and coordinates obtained by the steps of: (a) obtaining a first earth image from a first earth view, the first earth image comprising a plurality of pixels; (b) locating at least a first pixel in the first earth image associated with a point, the point having known earth location coordinates; (c) calculating a compensation factor based on a comparison between an expected pixel location of the point within the first earth image and the known location of the first pixel within the first earth image; (d) obtaining a second earth image from a second earth view, the second earth image comprising a plurality of pixels and not overlapping the first earth image; and (e) determining earth location coordinates for at least one pixel of the second earth image based on the compensation factor.

A further embodiment provides a method for transporting a satellite image towards an interested entity. The method comprises the steps of: (a) providing at least a portion of a communication network operable to convey digital data; and (b) conveying, over the portion of the communication network, a digital image that includes a plurality of pixels, at least one of the pixels having associated ground location information derived based on a compensation factor that has been determined based on at least one ground point from a first image, wherein said first image is different than said digital image and said first image does not overlap said digital image.

### BRIEF DESCRIPTION OF THE DRAWINGS

FIG. 1 is a diagrammatic illustration of a satellite in an earth orbit obtaining an image of the earth;

FIG. 2 is a block diagram representation of a satellite of an embodiment of the present invention;

FIG. 3 is a flow chart illustration of the operational steps for determining location coordinates associated with a satellite image for an embodiment of the present invention;

FIG. 4 is an illustration of a reference image covering points whose precise locations are known; and

FIG. 5 is an illustration of a path containing several imaged areas for an embodiment of the present invention.

### DETAILED DESCRIPTION

Generally, the present invention is directed to the determination of ground location information associated with at least one pixel of an image acquired by an imaging system aboard a satellite or other remote sensing platform. The process involved in producing the ground location information includes (a) obtaining one or more images (reference images) of areas covering points whose locations are precisely known, (b) predicting the locations of these points using time varying position, attitude, and distortion information available for the imaging system, (c) comparing the predicted locations with the known locations using a data fitting algorithm to derive one or more compensation factors, (d) interpolating or extrapolating the compensation factor(s) to other instants in time, and then (e) applying the compensation factor(s) to one or more other images (target images) of areas which are not covering points with the precisely known locations of the reference images. The process can be applied to a target image that does not overlap the reference image, and may also be applied to a target image that does overlap the reference image.

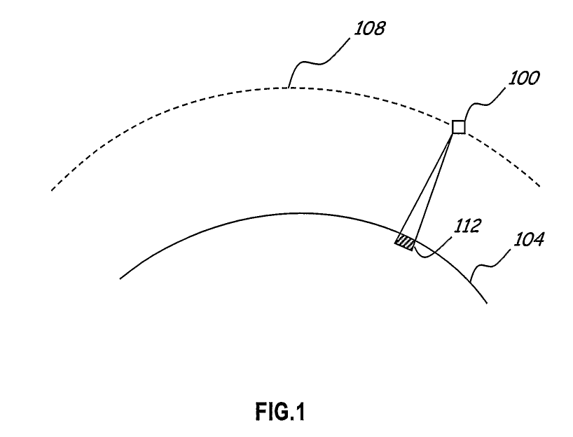

Having generally described the process for producing the image and ground location information, an embodiment of the process is described in greater detail. Referring to FIG. 1, an illustration of a satellite 100 orbiting a planet 104 is now described. At the outset, it is noted that, when referring to the earth herein, reference is made to any celestial body of which it may be desirable to acquire images or other remote sensing information having a related location associated with the body. Furthermore, when referring to a satellite herein, reference is made to any spacecraft, satellite, aircraft, or other remote sensing platform that is capable of acquiring images. It is also noted that none of the drawing figures contained herein are drawn to scale, and that such figures are for the purposes of illustration only.

As illustrated in FIG. 1, the satellite 100 orbits the earth 104 following orbital path 108. The position of the satellite 100 along the orbital path 108 may be defined by several variables, including the in-track location, cross-track location, and radial distance location. In-track location relates to the position of the satellite along the orbital path 108 as it orbits the earth 104. Cross-track location relates to the lateral position of satellite 100 relative to the direction of motion in the orbit 108 (relative to FIG. 1, this would be in and out of the page). Radial distance relates to the radial distance of the satellite 100 from the center of the earth 104. These factors related to the physical position of the satellite are collectively referred to as the ephemeris of the satellite. When referring to “position” of a satellite herein, reference is made to these factors. Also, relative to the orbital path, the satellite 100 may have pitch, yaw, and roll orientations that are collectively referred to as the attitude of the satellite 100. An imaging system aboard the satellite 100 is capable of acquiring an image 112 that includes a portion the surface of the earth 104. The image 112 is comprised of a plurality of pixels.

When the satellite 100 is acquiring images of the surface of the earth 104, the associated ground location of any particular image pixel(s) may be calculated based on information related to the state of the imaging system, including the position of the system, attitude of the system, and distortion information, as will be described in more detail below. The ground location may be calculated in terms of latitude, longitude, and elevation, or in terms of any other applicable coordinate system. It is often desirable to have knowledge of the location of one or more features associated with an image from such a satellite, and, furthermore, to have a relatively accurate knowledge of the location of each image pixel. Images collected from the satellite may be used in commercial and non-commercial applications. The number of applications for which an image 112 may be useful increases with higher resolution of the imaging system, and is further increased when the ground location of one or more pixels contained in the image 112 is known to higher accuracy.

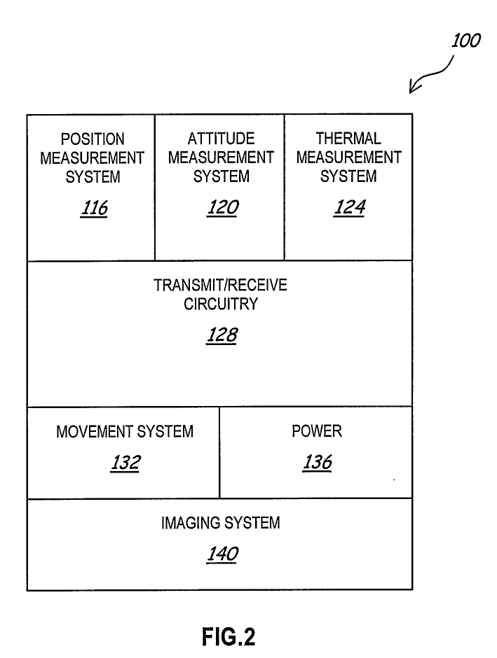

Referring now to FIG. 2, a block diagram representation of an imaging satellite 100 of an embodiment of the present invention is described. The imaging satellite 100 includes a number of instruments, including a position measurement system 116, an attitude measurement system 120, a thermal measurement system 124, transmit/receive circuitry 128, a satellite movement system 132, a power system 136, and an imaging system 140. The position measurement system 116 of this embodiment includes a Global Positioning System (GPS) receiver, which receives position information from a plurality of GPS satellites, and is well understood in the art. The position measurement system 116 obtains information from the GPS satellites at periodic intervals. If the position of the satellite 100 is desired to be determined for a point in time between the periodic intervals, the GPS information from the position measurement system is combined with other information related to the orbit of the satellite to generate the satellite position for that particular point in time. As is typical in such a system, the position of the satellite 100 obtained from the position measurement system 116 contains some amount of error, resulting from the limitations of the position measurement system 116 and associated GPS satellites. In one embodiment, the position of the satellite 100, using data derived and refined from the position measurement system 116 data, is known to within several meters. While this error is small, it is often a relatively significant contributor to uncertainty in ground location associated with pixels in the ground image.

The attitude measurement system 120 is used in determining attitude information for the imaging system 140. In one embodiment, the attitude measurement system 120 includes one or more gyroscopes that measure angular rate and one or more star trackers that obtain images of various celestial bodies. The location of the celestial bodies within the images obtained by the star trackers is used to determine the attitude of the imaging system 140. The star trackers, in an embodiment, are placed to provide roll, pitch, and yaw orientation information for a reference coordinate system fixed to the imaging system 140. Similarly as described above with respect to the position measurement system 116, the star trackers of the attitude measurement system operate to obtain images at periodic intervals. The attitude of the imaging system 140 can, and often does, change between these periodic intervals. For example, in one embodiment, the star trackers collect images at a rate of about 10 Hz, although the frequency may be increased or decreased. In this embodiment, the imaging system 140 operates to obtain images at line rates between 7 kHz and 24 kHz, although these frequencies may also be increased or decreased. In any event, the imaging system 140 generally operates at a higher rate than the star trackers, resulting in numerous ground image pixels being acquired between successive attitude measurements from the star trackers. The attitude of the imaging system 140 for time periods between successive images of the star trackers is determined using star tracker information along with additional information, such as angular rate information from the gyroscopes, to predict the attitude of the imaging system 140. The gyroscopes are used to detect the angular rates of the imaging system 140, with this information used to adjust the attitude information for the imaging system 140. The attitude measurement system 120, also has limitations on the accuracy of information provided, resulting in errors in the predicted attitude of the imaging system 140. While this error is generally small, it is often a relatively significant contributor to uncertainty in ground location associated with pixels in the ground image.

The thermal measurement system 124 is used in determining thermal characteristics of the imaging system 140. Thermal characteristics are used, in this embodiment, to compensate for thermal distortion in the imaging system 140. As is well understood, a source of error when determining ground location associated with an image collected by such a satellite-based imaging system 140 is distortion in the imaging system. Thermal variations monitored by the thermal measurement system 124 are used in this embodiment to compensate for distortions in the imaging system 140. Such thermal variations occur, for example, when the satellite 100, or portions of the satellite 100, move in or out of sunlight due to shadows cast by the earth or other portions of the satellite 100. The difference in energy received at the components of the imaging system 140 results in the components being heated, thereby resulting in distortion of the imaging system 140 and/or changes in the alignments between the imaging system 140 and the position and attitude measurement systems 116 and 120. Such energy changes may occur when, for example, a solar panel of the satellite 100 changes orientation relative to the satellite body and results in the imaging system components being subject to additional radiation from the sun. In addition to reflections from component parts of the satellite 100, and to the satellite 100 moving into and out of the earth's shadow, the reflected energy from the earth itself may cause thermal variations in the imaging system 140. For example, if the portion of the earth which is reflecting light to the imaging system 140 is particularly cloudy, more energy is received at the satellite 100 relative to the energy received over a non-cloudy area, thus resulting in additional thermal distortions. The thermal measurement system 124 monitors changing thermal characteristics, and this information is used to compensate for such thermal distortions. The thermal measurement system 124, has limitations on the accuracy of information provided, resulting in errors in the thermal compensation of the imaging system 140 of the satellite 100. While this error is generally relatively small, when used in determining the ground location of pixels within an image that includes a portion of the surface of the earth, this error also contributes to uncertainty in ground location.

In addition to thermal distortions from the imaging system 140, atmospheric distortions may also be present which increase the error of the imaging system 140. Such atmospheric distortions may be caused by a variety of sources within the atmosphere associated with the area being imaged, including heating, water vapor, pollutants, and a relatively high or low concentration of aerosols, to name a few. The image distortions resulting from these atmospheric distortions are a further component of error when determining ground location information associated with an area being imaged by the imaging system 140. Furthermore, in addition to the errors in position, attitude, and distortion information, the velocity at which the satellite 100 travels results in relativistic distortions in information received. In one embodiment, the satellite 100 travels at a velocity of about seven and one-half kilometers per second. At this velocity relativistic considerations, while relatively small, are nonetheless present and in one embodiment images collected at the satellite 100 are compensated to reflect such considerations. Although this compensation is performed to a relatively high degree of accuracy, some error still is present as a result of the relativistic changes. While this error is generally small, it is often a relatively significant contributor to uncertainty in ground location associated with pixels in the ground image.

The added error of the position measurement system 116, the attitude measurement system 120, thermal measurement system 124, atmospheric distortion, and relativistic changes result in ground location calculations having a degree of uncertainty which, in one embodiment, is about 20 meters. While this uncertainty is relatively small for typical satellite imaging systems, further reduction of this uncertainty would increase the utility of the ground images for a large number of users, and also enable the images to be used in a larger number of applications.

The transmit/receive circuitry 128 in this embodiment includes well known components for communications with the satellite 100 and ground stations and/or other satellites. The satellite 100 generally receives command information related to controlling the positioning of the satellite 100 and the pointing of the imaging system 140, various transmit/receive antennas, and/or solar panels. The satellite 100 generally transmits image data along with satellite information from the position measurement system 116, attitude measurement system 120, thermal measurement system 124, and other information used for the monitoring and control of the satellite system 100.

The movement system 132 contains a number of momentum devices and thrust devices. The momentum devices are utilized in control of the satellite 100 by providing inertial attitude control, as is well understood in the art. As is also understood in the art, satellite positions are controlled by thrust devices mounted on the satellite that operate to position the satellite 100 in various orbital positions. The movement system may be used to change the satellite position and to compensate for various perturbations that result from a number of environmental factors such as solar array or antenna movement, atmospheric drag, solar radiation pressure, gravity gradient effects, or other external or internal forces.

The satellite system 100 also contains a power system 136. The power system may be any power system used in generating power for a satellite. In one embodiment, the power system includes solar panels (not shown) having a plurality of solar cells which operate to generate electricity from light received at the solar panels. The solar panels are connected to the remainder of the power system, which includes a battery, a power regulator, a power supply, and circuitry which operates to change the relative orientation of the solar panels with respect to the satellite system 100 in order to enhance power output from the solar panels by maintaining proper alignment with the sun.

The imaging system 140, as mentioned above, is used to collect images that include all or a portion of the surface of the earth. The imaging system 140, in one embodiment, utilizes a pushbroom type imager operating to collect lines of pixels at an adjustable frequency between 7 kHz and 24 kHz. The imaging system 140 may include a plurality of imagers which operate to collect images in different wavelength bands. In one embodiment the imaging system 140 includes imagers for red, green, blue, and near infrared bands. The images collected from these bands may be combined in order to produce a color image of visible light reflected from the surface being imaged. Similarly, the images from any one band, or combination of bands, may be utilized to obtain various types of information related to the imaged surface, such as agricultural information, air quality information, and the like. While four bands of imagery are described, more or fewer bands of imagery are collected in other embodiments. For example, infrared and ultraviolet imagery may be collected, depending upon the applications for which the images will be used. In one embodiment, the imaging system 140 includes imagers comprising an array of CCD pixels, each pixel capable of acquiring up to 2048 levels of brightness and then representing this brightness with 11 bits of data for each pixel in the image.

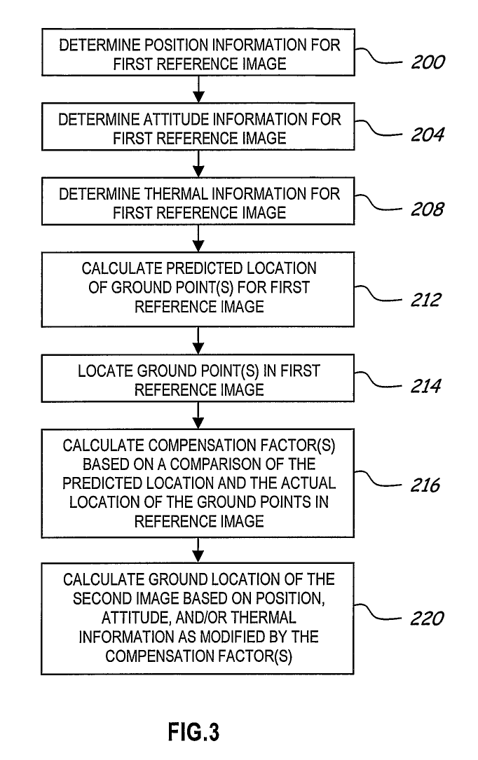

Referring now to FIG. 3, the operational steps used in the determination of ground location information for an area imaged by a satellite system are described for an embodiment of the invention. In one embodiment, the satellite continuously collects images along its orbital path. These images, along with information from the position measurement system, attitude measurement system, and thermal measurement system, are sent via one or more ground stations to an image production system where the images and associated position, attitude, and distortion information are processed along with any other known information related to the satellite system. The processing may occur at any time, and may be done at near real-time. In this embodiment, the images include both reference images and target images. As mentioned previously, reference images are images that overlap one or more ground points having location coordinates that are known to a high degree of accuracy, and target images are images that do not overlap ground points having location coordinates that are known to a high degree of accuracy. In the embodiment of FIG. 3, the position of the satellite is determined for a first reference image, as indicated at block 200. The position, as described above, includes information related to the orbital position of the satellite at the time the first reference image was collected, and includes in-track information, cross-track information, and radial distance information. The position may be determined using information from the position measurement system and other ground information used to improve the overall position knowledge. At block 204, the attitude information for the imaging system is determined. The attitude of the imaging system, as previously discussed, includes the pitch, roll, and yaw orientation of the imaging system relative to the orbital path of a reference coordinate system of the imaging system. When determining the attitude information, information is collected from various attitude measurement system components. This information is analyzed to determine the attitude of the imaging system. At block 208, the distortion information for the imaging system is determined. The distortion information includes known variances in the optic components of the imaging system, along with thermal distortion variations of the optic components as monitored by the thermal measurement system. Also included in the distortion information is distortion from the earth's atmosphere.

Following the determination of the position, attitude, and distortion information, the predicted pixel location of at least one predetermined ground point is calculated, according to block 212. In one embodiment, this predicted pixel location is determined using the position of the imaging system, attitude of the imaging system, and distortion of the imaging system to calculate a ground location of at least one pixel from the image. Specifically the position provides the location of the imaging system above the earth's surface, the attitude provides the direction from which the imaging system is collecting images, and the distortion provides the amount by which the light rays are skewed from what they would be if there were no thermal, atmospheric, or relativistic effects. The position of the imaging system, along with the direction in which the imaging system is pointed, and the effects of distortion on the imaging system result in a theoretical location on the earth's surface which produced the light received by the imaging system. This theoretical location is then further adjusted based on surface features of the location on the earth's surface, such as mountainous terrain. This additional calculation is made, and the predicted pixel location is produced.

Following the determination of the predicted pixel location of each predetermined ground point in the reference image, a compensation factor is calculated for one or more of the position, attitude, and distortion information based on a comparison between the predicted pixel location of each predetermined ground point in the reference image and the actual pixel location of each predetermined ground point, as indicated at block 216. The calculation of the compensation factor(s) will be described in more detail below.

Following the calculation of the compensation factor(s), the ground location of at least one pixel in other images collected by the imaging system may be computed using the compensated attitude, position, and/or distortion information. In the embodiment of FIG. 3, the compensation factor(s) are utilized if the location accuracies of the pixels in the target images are better than accuracies achievable using other conventional methods. As discussed above, the satellite has various perturbations and temperature fluctuations throughout every orbit. Thus, when compensation factor(s) are calculated based on the difference between a predicted pixel location of a predetermined ground point in a reference image and an actual pixel location of the predetermined ground point in the reference image, further changes in the position, attitude, or distortion of the imaging system will reduce the accuracy of the compensation factor(s), until, at some point, the ground locations of pixels predicted using standard sensor-derived measurements are more accurate than the ground locations determined using the compensation factor(s). In such a case, the compensation factor(s) may not used, and the ground locations of pixels predicted using standard sensor-derived measurements are utilized for ground location information. The ground location of one or more pixels in the second image is determined utilizing the compensation factor(s), as noted at block 220. In this manner, the ground location of images acquired before and/or after acquiring a reference image may be determined to a relatively high degree of accuracy. Furthermore, if multiple reference images are taken during an orbit while collecting images, it may be possible to determine the ground location of all of the images taken for that orbit utilizing adjustment factors generated from the respective reference images.

It is noted that the order in which the operational steps are described with respect to FIG. 3 may be modified. For example, the second image may be acquired prior to the reference image being acquired. The compensation factor may be applied to the second image, even though the second image was acquired prior to the acquisition of the reference image. In another embodiment, multiple reference images are taken, and a fitting algorithm is applied to the predicted locations for each predetermined ground point in each image to derive a set of compensation factors for various images acquired between the acquisition of reference images. Such a fitting algorithm may be a least squares fit.

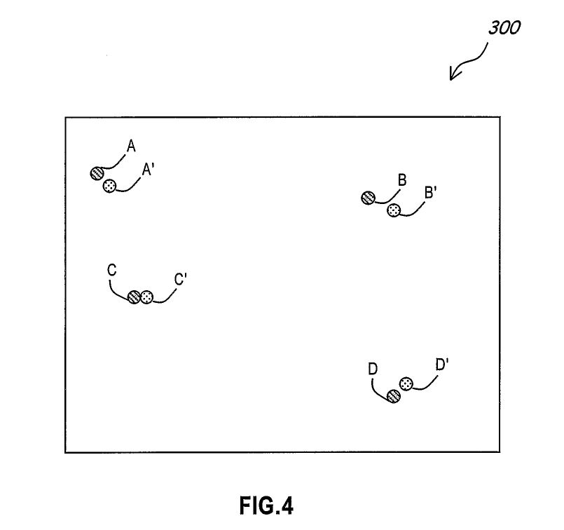

Referring now to FIG. 4, the determination of the compensation factor(s) for one embodiment of the invention is now described. As discussed previously, the imaging system aboard an imaging satellite acquires a reference image 300, overlapping one or more predetermined ground points. The location on the earth of each predetermined ground point may be expressed in terms of latitude, longitude, and elevation, relative to any appropriate datum, such as WGS84. Such a predetermined ground point may be any identifiable natural or artificial feature included in an image of the earth having a known location. Examples of predetermined ground points include sidewalk corners, building corners, parking lot corners, coastal features, and identifiable features on islands. One consideration in the selection of a predetermined ground point is that it be relatively easy to identify in an image of the area containing the predetermined ground point. A point which has a high degree of contrast compared to surrounding area within an image, having a known location is often desirable, although a predetermined ground point may be any point which is identifiable either by a computing system, or a human user. In one embodiment, image registration is used to determine the amount of error present in the computed locations of the predetermined ground point. Such image registration may be general feature based, line feature based, and/or area correlation based. Area correlation based image registration evaluates an area of pixels around a point, and registers that area to an area of similar size in a control image. The control image has been acquired by a remote imaging platform and has actual area locations known to a high degree of accuracy. The amount of error present between the predicted location for the area and the actual location of the area is used in determining the compensation factors. Feature and line registration identify and match more specific items in an image, such as the edge of a building or a sidewalk. Groups of pixels are identified that outline or delineate a feature, and that grouping of pixels is compared to the same grouping in a control image. In one embodiment, predetermined ground points are selected in locations where the likelihood of cloud cover is reduced, in order to have increased likelihood that the predetermined ground point will be visible when the reference image 300 is collected.

Referring again to FIG. 4, the predicted pixel locations of four predetermined ground points illustrated as A, B, C, and D are determined for the reference image 300. The locations of A, B, C, and D as illustrated in FIG. 4 are the predicted pixel locations of A, B, C, D based on attitude, position, and distortion information for the imaging satellite, and surface location information such as elevation for the earth location. The actual pixel locations of the predetermined ground points, identified as A′, B′, C′, and D′, are known a priori to a high degree of accuracy. The difference between the predicted pixel locations and the actual pixel locations is then utilized to determine the compensation factor. In one embodiment, the compensation factor is a modified imaging system attitude. In another embodiment, the compensation factor is a modified imaging system attitude and a modified imaging system position. In yet another embodiment, the compensation factor is a modified imaging system attitude and a modified imaging system position, and modified distortion information. In embodiments where more than one of the imaging system attitude, position, and distortion are compensated, one factor may be receive more compensation relative to another factor, and in an embodiment, the attitude receives a relatively large amount of the compensation, and the position and distortion receive a relatively small amount of the compensation.

The compensation factor is determined, in one embodiment, by solving a set of equations having variables related to position of the imaging system, attitude of the imaging system, distortion of the imaging system, and the ground location of images acquired by the imaging system. In one embodiment, where imaging system attitude is compensated, the position of the imaging system determined at block 200 in FIG. 3 is assumed to be correct, the distortion of the imaging system determined at block 208 in FIG. 3 is assumed to be correct, and the ground location of a pixel corresponding to a predetermined ground point from the reference image is set to be the known location of the predetermined ground point identified in the reference image. The equations are then solved to determine the compensated attitude of the imaging system. This compensated attitude is then used in other images in determining the ground location of pixels within the other images.

In one embodiment, triangulation is used to compute the compensated imaging system attitude. Triangulation, in this embodiment, is performed using a state-space estimation approach. The state-space approach to the triangulation may utilize least squares, least squares utilizing apriori information, or stochastic or Bayesian estimation such as a Kalman filter. In an embodiment utilizing a basic least squares approach, it is assumed that the position is correct, the distortion is correct, and that the ground location associated with a pixel in the reference image corresponding to a predetermined ground point is correct. The attitude is then solved for and utilized as the compensation factor.

In another embodiment, a least squares approach utilizing a priori information is utilized to determine the compensation factor. In this embodiment, the imaging system position, attitude, distortion and pixel location of the predetermined ground point, along with a priori covariance information related to each of these factors are utilized in calculating the compensation factor. In this embodiment, all of the factors may be compensated, with the amount of compensation to each parameter controlled by their respective covariances. Covariance is a measure of uncertainty, and may be represented by a covariance matrix. For example, a 3×3 covariance matrix may be used for position of the imaging system, with elements in the matrix corresponding to the in-track, cross-rack, and radial distance position of the imaging system. The 3×3 matrix includes diagonal elements that are the variance of the position error for each axis of position information, and the off-diagonal elements are correlation factors between position errors for each element. Other covariance matrices may be generated for imaging system attitude information, distortion information, and the predetermined ground point location.

Using least squares or Kalman filter with a priori covariances, compensations are generated for each parameter. In addition, covariances associated with each parameter are also produced. Hence, the a posteriori covariance of the improved attitude, for example, is known using the covariance associated with the attitude corrections.

As described above, in one embodiment two or more reference images are collected and utilized to calculate the compensation factor. In this embodiment, triangulation (via the methods described above) is performed on each image independently to determine compensation factors for each. These compensation factors are then combined for use in determining ground locations associated with images collected in which ground location is determined without using predetermined ground points. The compensation factors may be combined using methods such as interpolation, polynomial fit, simple averaging, covariance-weighted averaging, etc. Alternatively a single triangulation (using the same methods described above) is performed on all the images together, resulting in a global compensation factor that would apply to the entire span of orbit within the appropriate timeframe. This global compensation factor could be applied to any image without using predetermined ground points.

While the position parameters described above are assumed to be correct, or to have a small covariance, when determining compensated imaging system attitude information, other alternatives may also be used. In the above-described embodiment, imaging system attitude is selected because, in this embodiment, the imaging system attitude is the primary source of uncertainty. By reducing the primary source of uncertainty, the accuracy of the ground locations associated with other images which do not overlap ground control points is increased. In other embodiments, where imaging system attitude is not the primary source of uncertainty, other parameters may be compensated as appropriate.

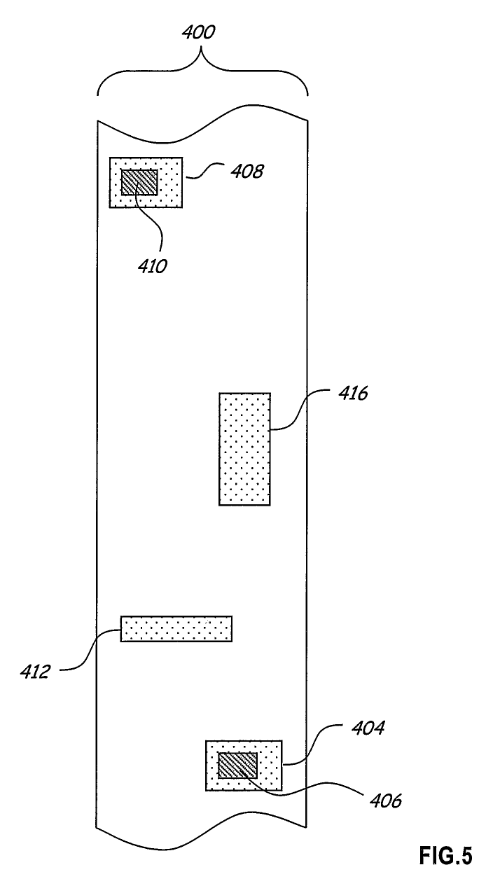

As discussed previously, in one embodiment multiple reference images are collected from a particular orbit of the imaging system. In this embodiment, as illustrated in FIG. 5, various images are collected within a satellite ground access swath 400. Included in the collected images are a first reference image 404, and a second reference image 408. The reference images 404, 408 are collected from areas within the satellite ground access swath 400 which overlap predetermined ground points. The areas which contain actual predetermined ground points are indicated as cross-hatched control images 406, 410 in FIG. 5. In the example illustrated in FIG. 5, a third image 412 and a fourth image 416 are also acquired, neither of which overlap any predetermined ground points. Images 412, 416 are target images. In this embodiment, the actual locations of predetermined ground points contained in the first reference image 404 are compared with predicted locations of predetermined ground points contained in the first reference image 404. A first compensation factor is determined based on the difference between the predicted predetermined ground point locations and the actual predetermined ground point locations.

Similarly, the actual locations of the predetermined ground points contained in the second reference image 408 are compared with predicted locations of predetermined ground points contained in the second reference image 408. A second compensation factor is determined based on the difference between the predicted predetermined ground point location and the actual predetermined ground point locations. A combination of the first and second compensation factors, as described above, may then be utilized to determine the ground locations for one or more pixels in each of the target images 412, 416.

The imaging system of the satellite may be controlled to acquire the various images in any order. For example, the satellite may acquire the third and fourth images 412, 416, and then acquire the first and second reference images 404, 408. In one embodiment, the images are acquired in the following order: the first reference image 404 is acquired, followed by the third image 412, followed by the fourth image 416, and finally the second reference image 408 is acquired. In this example, the compensation factor for the third and fourth image 412, 416 is calculated according to a least squares fit of the first and second compensation factors. If the images were acquired in a different order, it would be straightforward, and well within the capabilities of one of ordinary skill in the art, to calculate compensation factors for the third and fourth images 412, 416 utilizing similar techniques.

As mentioned previously, the satellite transmits collected images to at least one ground station located on the earth. The ground station is situated such that the satellite may communicate with the ground station for a portion of an orbit. The images received at a ground station may be analyzed at the ground station to determine location information for the pixels in the images, with this information sent to a user or to a data center (hereinafter referred to as a receiver). Alternatively, the raw data received from the satellite at the ground station may be sent from the ground station to a receiver directly without any processing to determine ground location information associated with images. The raw data, which includes information related to position, attitude, and distortion of the imaging system may then be analyzed to determine images containing predetermined ground points. Using the predetermined ground points in those images, along with other information as described above, the ground locations for pixels in other images may be calculated. In one embodiment, the image(s) are transmitted to the receiver by conveying the images over the Internet. Typically, an image is conveyed in a compressed format. Once received, the receiver is able to produce an image of the earth location along with ground location information associated with the image. It is also possible to convey the image(s) to the receiver in other ways. For instance, the image(s) can be recorded on a magnetic disk, CD, tape or other recording medium and mailed to the receiver. If needed the recording medium can also include the satellite position, attitude, and distortion information. It is also possible to simply produce a hard copy of an image and then mail the hardcopy the receiver. The hard copy can also be faxed or otherwise electronically sent to the receiver.

While the invention has been particularly shown and described with reference to a preferred embodiment thereof, it will be understood by those skilled in the art that various other changes in the form and details may be made without departing from the spirit and scope of the invention.

1. A method for determining location information of an earth image from a remote imaging platform, comprising:
obtaining a first earth image associated with a first earth view;
obtaining a second earth image associated with a second earth view, said second earth view not overlapping said first earth view; and
using known location information associated with said first earth image to determine location information associated with said second earth image.

2. The method for determining location information of an earth image from a remote imaging platform, as claimed in claim 1, wherein said step of obtaining a second earth image is performed before said step of obtaining a first earth image.

3. The method for determining location information of an earth image from a remote imaging platform, as claimed in claim 1, wherein said step of obtaining a second earth image is performed after said step of obtaining a first earth image.

4. The method for determining location information of an earth image from a remote imaging platform, as claimed in claim 1, wherein said step of using comprises:
determining known location information of at least one object of said first earth image;
using said known location information and imaging platform movement information to determine a compensation factor and an error measurement associated with said compensation factor for said second earth image; and
using said compensation factor to determine location information associated with said second earth image when a magnitude of said error measurement is less than a predetermined error limit.

5. The method for determining location information of an earth image from a remote imaging platform, as claimed in claim 4, wherein said predetermined error limit is an error limit associated with an attitude, position, and distortion measurement system associated with the imaging platform.

6. A method for determining location information of an earth image acquired from an imaging system aboard a satellite, comprising:
obtaining a first earth image associated with a first earth view;
obtaining a second earth image associated with a second earth view, said second earth view not overlapping said first earth view;
locating at least a first ground point in said first image having known earth location information;
determining an expected location of said ground point in said first image using at least one of position, attitude, and distortion information of the imaging system;
calculating at least one compensation factor based on a comparison between said expected location information and said known location information of said first ground point; and
determining location information of said second image based on said compensation factor.

7. The method for determining location information of an earth image acquired from an imaging system aboard a satellite, as claimed in claim 6, wherein said step of obtaining a second earth image is performed before said step of obtaining a first earth image.

8. The method for determining location information of an earth image acquired from an imaging system aboard a satellite, as claimed in claim 6, wherein said step of obtaining a second earth image is performed after said step of obtaining a first earth image.

9. The method for determining location information of an earth image acquired from an imaging system aboard a satellite, as claimed in claim 6, wherein said calculating step comprises:
determining a first position of the imaging system when said first image was acquired by the imaging system;
determining a first attitude of the imaging system when said first image was acquired by the imaging system;
determining a first distortion of the imaging system when said first image was acquired by the imaging system; and
solving for said at least one compensation factor for at least one of a position, attitude, and distortion of said imaging system based on the difference between the location of said first ground point in said first image and said expected location of said ground point.

10. The method for determining location information of an earth image acquired from an imaging system aboard a satellite, as claimed in claim 6, wherein said determining location information step comprises:
determining a second position of the imaging system when said second image was acquired by the imaging system, said second position modified by said at least one compensation factor;
determining a second attitude of the imaging system when said second image was acquired by the imaging system, said second attitude modified by said at least one compensation factor;
determining a second distortion of the imaging system when said second image was acquired by the imaging system, said second distortion modified by said at lease one compensation factor; and
determining location information for at least one location in said second image.

11. The method for determining location information of an earth image acquired from an imaging system aboard a satellite, as claimed in claim 6, wherein said calculating step comprises:
determining a first position and associated covariance of the imaging system when said first image was acquired;
determining a first attitude and associated covariance of the imaging system when said first image was acquired;
determining a first distortion and associated covariance of the imaging system when said first image was acquired;
solving for said at least one compensation factor for each of a position, attitude, and distortion of said imaging system based on the difference between the location of said first ground point in said first image and said expected location of said ground point, wherein said compensation factors are weighted by their respective covariances.

12. A satellite image of an earth view comprising a plurality of pixels and earth location coordinates of at least one of said pixels, said plurality of pixels and coordinates obtained by:
obtaining a first earth image from a first earth view, said first earth image comprising a plurality of pixels;
determining a first pixel location of at least a first pixel in said first earth image associated with a first ground point having a known earth location;
calculating a compensation factor based on a comparison between an expected pixel location of said first ground point and said first pixel location;
obtaining a second earth image from a second earth view, said second earth image comprising a plurality of pixels, and said second earth image not overlapping said first earth image; and
determining an earth location for at least one pixel of said second earth image based on said compensation factor.

13. The satellite image, as claimed in claim 12, wherein said step of obtaining a second earth image is performed before said step of obtaining a first earth image.

14. The satellite image, as claimed in claim 12, wherein said step of obtaining a second earth image is performed after said step of obtaining a first earth image.

15. The satellite image, as claimed in claim 12, wherein said calculating step comprises:
determining a first position and associated covariance of an imaging system associated with the satellite when said first earth image was acquired;
determining a first attitude and associated covariance of the imaging system when said first image was acquired;
determining a first distortion and associated covariance of the imaging system when said first image was acquired;
calculating said expected pixel location of said first ground point based on said first position, attitude, and distortion;
determining a difference between said expected pixel location and said first pixel location;
solving for at least one compensation factor for each of a position, attitude, and distortion of said imaging system based on said difference, wherein said compensation factors are weighted by their respective covariances.

16. The satellite image, as claimed in claim 12, wherein said determining an earth location step comprises:
determining a second position of the imaging system when said second earth image was acquired;
determining a second attitude of the imaging system when said second earth image was acquired;
determining a second distortion of the imaging system when said second earth image was acquired;
applying said compensation factor to at least one of said second position, attitude and distortion; and
determining an earth location for at least one pixel in said second earth image.

17. A method for transporting a satellite image towards an interested entity, comprising:
providing at least a portion of a communication network operable to convey digital data; and
conveying, over said portion of a communication network, a digital image of an earth view that includes a plurality of pixels, at least one of said pixels having associated ground location information derived based on a compensation factor that has been determined based on at least one ground point from a first image, wherein said first image is different than said digital image and said first image does not overlap said digital image.

18. The method of claim 17, wherein said ground location information includes the longitude, latitude, and altitude associated with said at least one pixel.

19. The method of claim 17, wherein said digital image is obtained using an imaging satellite.

20. The method of claim 17, wherein said digital image is collected before said first image.

21. The method of claim 17, wherein said digital image is collected after said first image.
